(19) United States
(12) Patent Application Publication
(10) Pub. No.: US 2013/0208291 A1
(43) Pub. Date: Aug. 15, 2013

(54) IMAGE FORMING APPARATUS, METHOD OF CONTROLLING THE SAME, AND STORAGE MEDIUM

(71) Applicant: Canon Kabushiki Kaisha, (US)

(72) Inventor: Motoki Ikeda, Tokyo (JP)

(73) Assignee: CANON KABUSHIKI KAISHA, Tokyo (JP)

(21) Appl. No.: 13/712,881

(22) Filed: Dec. 12, 2012

(30) Foreign Application Priority Data
Feb. 10, 2012 (JP) 2012-027726

(51) Int. Cl. G06F 3/12

(52) U.S. Cl. CPC G06F 3/1297
USPC 358/1.13

(57) ABSTRACT

This invention provides an image forming apparatus that introduces a touch input operation in preview for preventing an error output, and suitably controls the touch input operation to prevent an error output caused by the touch input operation, a method of controlling the same, and a program. To accomplish this, the image forming apparatus accepts a touch input operation for scrolling display contents, and when preview for preventing an error output is not being displayed, sets the scroll speed of display contents by the touch input operation to a first speed. When the preview for preventing an error output is being displayed, the image forming apparatus sets the scroll speed of the display contents by the touch input operation to a second speed lower than the first speed.

### BACKGROUND OF THE INVENTION

1. Field of the Invention

The present invention relates to an image forming apparatus for previewing a document, a method of controlling the same, and a storage medium.

2. Description of the Related Art

In an image forming apparatus such as a multifunction peripheral, the user can confirm the contents of a document handled by the image forming apparatus by preview. In such preview, the image of each page of the document is individually displayed. To scroll a page, the user operates a button (a scroll button) or the like displayed on the display device of the operation unit of the multifunction peripheral, thereby selectively displaying each page.

On the other hand, an operation method by gestures such as a flick operation has recently been introduced to a terminal such as a smartphone or a tablet including a display device provided with a touch panel. The flick operation is an operation of flicking, by a finger, on a display object such as an image displayed on the display device. The display object on which the flick operation has been done is moved with animation in the flicking direction and displayed. It is therefore possible to offer the user intuitive operational feeling. With a flick operation for scrolling a page in which a plurality of display objects are simultaneously displayed, the plurality of display objects can be moved and scrolled at once. Hence, the user can quickly grasp the outline of the display objects.

Japanese Patent Laid-Open No. 2011-237636 has proposed a multifunction peripheral in which the above-described operability is introduced for preview of a document. When preview of a document including a plurality of pages is page-scrolled by the flick operation, the user can quickly grasp the outline of the entire document. This allows to conveniently shorten the time required for searching for a desired document out of an enormous number of documents managed by the multifunction peripheral.

Some multifunction peripherals display preview of a document before output of the document, and after the user has confirmed that the document to be output is correct, issues a final output instruction. This is to prevent an error output and reduce the security risk of resource waste and information leakage.

However, the related art has a problem to be described below. For example, in the related art, introducing the flick operation to the preview of the multifunction peripheral enables to efficiently quickly detect a desired document. On the other hand, in preview for preventing an error output (error printing), since the display contents quickly move, the user may overlook the contents. This leads to output of an undesirable document.

### SUMMARY OF THE INVENTION

The present invention enables realization of an image forming apparatus that introduces a gesture operation such as a flick operation in preview for preventing an error output, and performs control to prevent an error output caused by such a gesture operation, a method of controlling the same, and a storage medium.

One aspect of the present invention provides an image forming apparatus including a display unit that accepts a touch input operation, comprising: a display determination unit configured to determine whether or not contents currently displayed on the display unit represent preview for preventing an error output of a document by the image forming apparatus in a case where the display unit accepts a touch input operation for scrolling display contents; and a setting unit configured to set a scroll speed of the display contents by the touch input operation to a first speed in a case where the display determination unit has determined that the display unit is not displaying the preview for preventing the error output, and sets the scroll speed of the display contents by the touch input operation to a second speed lower than the first speed in a case where the display determination unit has determined that the display unit is displaying the preview for preventing the error output.

Another aspect of the present invention provides an image forming apparatus including a display unit that accepts a touch input operation, comprising: a display determination unit configured to determine whether or not contents currently displayed on the display unit represent preview for preventing an error output of a document by the image forming apparatus in a case where the display unit accepts a touch input operation for scrolling display contents; and a setting unit configured to set a scroll moving amount of the display contents by the touch input operation to a first moving amount in a case where the display determination unit has determined that the display unit is not displaying the preview for preventing the error output, and sets the scroll moving amount of the display contents by the touch input operation to a second moving amount smaller than the first moving amount in a case where the display determination unit has determined that the display unit is displaying the preview for preventing the error output.

Still another aspect of the present invention provides a method of controlling an image forming apparatus including a display unit that accepts a touch input operation, comprising: determining whether or not contents currently displayed on the display unit represent preview for preventing an error output of a document by the image forming apparatus in a case where the display unit accepts a touch input operation for scrolling display contents; and setting a scroll speed of the display contents by the touch input operation to a first speed in a case where it is determined in the determining that the display unit is not displaying the preview for preventing the error output, and setting the scroll speed of the display contents by the touch input operation to a second speed lower than the first speed in a case where it is determined in the determining that the display unit is displaying the preview for preventing the error output.

Yet still another aspect of the present invention provides a method of controlling an image forming apparatus including a display unit that accepts a touch input operation, comprising: determining whether or not contents currently displayed on the display unit represent preview for preventing an error output of a document by the image forming apparatus in a case where the display unit accepts a touch input operation for scrolling display contents; and setting a scroll moving amount of the display contents by the touch input operation to a first moving amount in a case where it is determined in the determining that the display unit is not displaying the preview for preventing the error output, and setting the scroll moving amount of the display contents by the touch input operation to a second moving amount smaller than the first moving amount in a case where it is determined in the determining that the display unit is displaying the preview for preventing the error output.

Still yet another aspect of the present invention provides a computer-readable storage medium storing a computer program that causes a computer to execute each step of the image forming apparatus control method.

Further features of the present invention will be apparent from the following description of exemplary embodiments with reference to the attached drawings.

### BRIEF DESCRIPTION OF THE DRAWINGS

FIG. 1 is a block diagram showing an example of the arrangement of an image forming apparatus according to the first embodiment;

FIG. 2 is a view showing examples of screens according to the first embodiment;

FIG. 3 is a flowchart showing an example of a processing procedure according to the first embodiment;

FIG. 4 is a view showing an example of a screen according to the second embodiment; and

FIG. 5 is a flowchart showing an example of a processing procedure according to the fourth embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Arrangement of Image Forming Apparatus

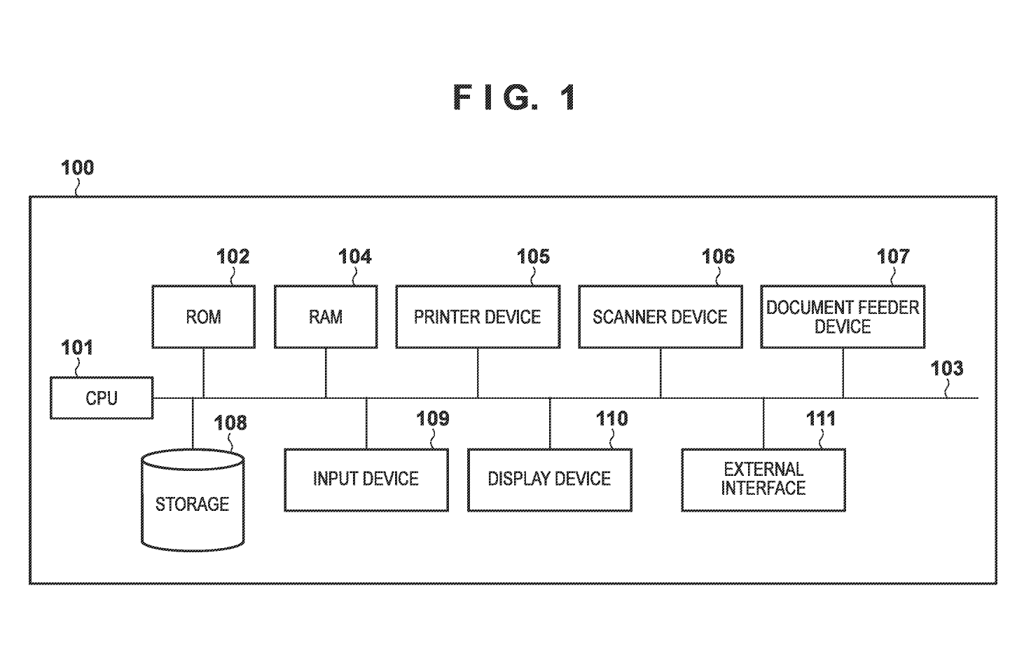

The first embodiment of the present invention will now be described with reference to FIGS. 1 to 3. An example of the arrangement of an image forming apparatus such as a digital multifunction peripheral according to this embodiment will be described first with reference to FIG. 1.

An image forming apparatus 100 includes a CPU 101, a ROM 102, a RAM 104, a printer device 105, a scanner device 106, a document feeder device 107, a storage 108, an input device 109, a display device 110, and an external interface 111. The devices are connected via a data bus 103 so as to be communicable with each other. The CPU 101 is a controller configured to generally control the whole image forming apparatus 100. The CPU 101 activates the OS (Operating System) by a boot program stored in the ROM 102. The CPU 101 executes, on the OS, a controller program stored in the storage 108. The controller program is a program to control the image forming apparatus 100.

The RAM 104 operates as a temporary storage area such as the main memory or work area of the CPU 101. The printer device 105 prints a document (image) on a paper sheet. The printer device 105 can use any one of, for example, an electrophotographic method using a photosensitive drum, a photosensitive belt, and the like, and an inkjet method of discharging ink from a tiny nozzle array and directly printing an image on a paper sheet.

The scanner device 106 scans a document of paper of the like using an optical reading device such as a CCD to obtain electrical signal data, and converts the data to generate an image. The CPU 101 bundles generated images (of the respective pages) and manages them as a document. The document feeder device 107 such as an ADF (automatic document feeder) feeds document pages placed on the document table of the document feeder device 107 to the scanner device 106 one by one.

The storage 108 is a readable and writable nonvolatile memory such as an HDD or an SSD. Various data such as the above-described controller program and various kinds of documents are saved in the storage 108. The input device 109 is an input device formed from a touch panel, hard keys, and the like and accepts a touch input operation. The input device 109 accepts a user operation instruction. The input device 109 transmits instruction information including an instruction position to the CPU 101. The display device 110 is a display device such as an LCD or a CRT. The display device 110 displays display data generated by the CPU 101 (displays a screen). Hence, in this embodiment, the input device 109 and the display device 110 are integrated and provided as an operation unit.

Based on instruction information received from the input device 109 and display data displayed on the display device 110, the CPU 101 can determine what kind of operation has been performed. The CPU 101 controls the image forming apparatus 100 in accordance with the determination result, and generates new display data and causes the display device 110 to display it. The external interface 111 transmits or receives various kinds of data including a document to or from another external device via a network such as a LAN, a telephone line, or close proximity wireless communication using an infrared ray. Note that the above explanation of the example of the arrangement of the image forming apparatus 100 also applies to the other embodiments. Note that the CPU 101 can detect, for example, the following operations and states of the touch panel included in the input device 109: touching the touch panel by a finger or a pen (to be referred to as “touch down” hereinafter); keeping the finger or pen in contact with the touch panel (to be referred to as “touch on” hereinafter); moving the finger or pen kept in contact with the touch panel (to be referred to as “move” hereinafter); releasing the finger or pen from the touch panel (to be referred to as “touch up” hereinafter); and a state in which nothing is in contact with the touch panel (to be referred to as “touch off” hereinafter). Each operation and the position coordinates of the finger or pen in contact with the touch panel are sent to the CPU 101 via the data bus 103. The CPU 101 determines, based on the received information, what kind of operation has been done on the touch panel. As for the move, even the moving direction of the finger or pen that moves on the touch panel can be determined for each of the vertical and horizontal components on the touch panel based on a change in the position coordinates. An operation from touch down on the touch panel to a predetermined move and then to touch up is assumed to be a stroke. A quick stroke operation is called a flick (touch input). The flick is an operation of quickly moving a finger kept in contact with the touch panel by a certain distance and then directly releasing it. In other words, the flick is an operation of quickly tracing the touch panel surface like flipping. Upon detecting a move for a predetermined distance or more at a predetermined speed or more and then detecting touch up, the CPU 101 can determine that a flick operation has been performed. If a move for a predetermined distance or more is detected, and directly touch on is detected, the CPU 101 determines that a drag operation has been performed. A touch panel of any one of various types such as a resistive type, a capacitance type, a surface acoustic wave type, an infrared type, an electromagnetic induction type, an image recognition type, and an optical sensor type is usable.

<Display Examples>

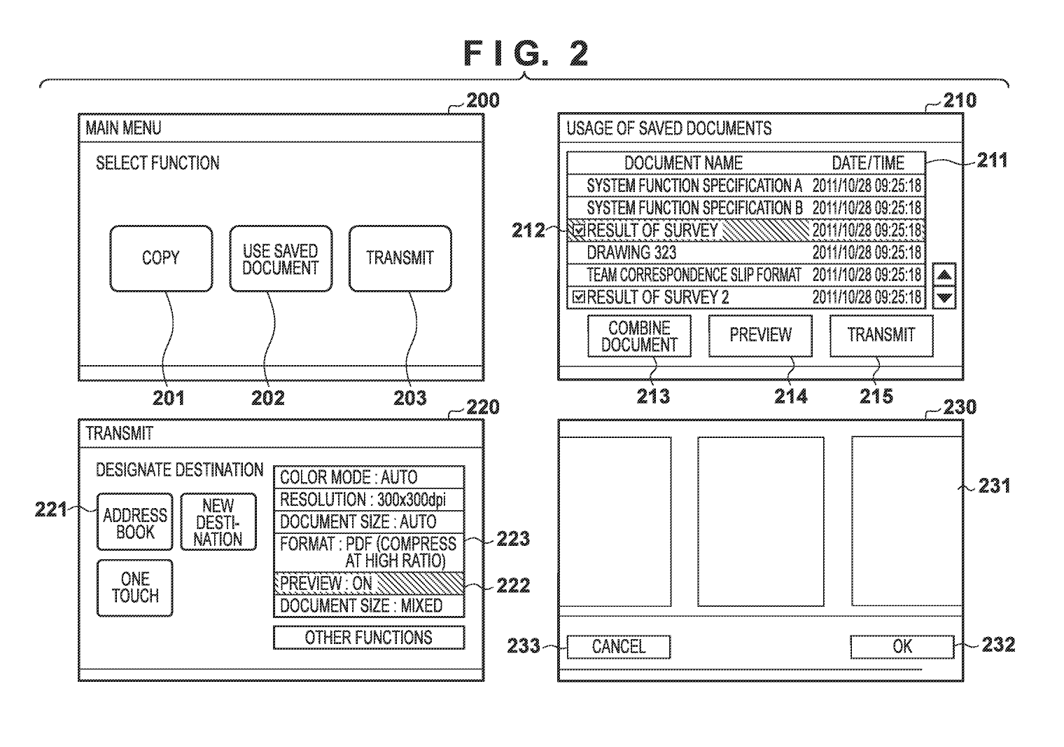

Display examples of the display device 110 according to this embodiment will be described next with reference to FIG. 2. As described above, the image forming apparatus 100 according to this embodiment implements display of a screen or acceptance of an operation instruction by the CPU 101, the input device 109, and the display device 110. The CPU 101 accepts a user operation instruction via the input device 109. The CPU 101 generates display data accordingly and causes the display device 110 to display it.

A screen 200 is used to select a function of the image forming apparatus 100. As shown in FIG. 2, buttons 201 to 203 corresponding to various kinds of functions are selectably displayed in the screen 200. The “copy” button 201 is selected to use the copy function of the image forming apparatus 100. Upon accepting an instruction to the “copy” button 201, the CPU 101 causes the display device 110 to display a screen (not shown) to instruct setting and execution of copy. The user can use the copy function by operations according to the screen.

The “use saved document” button 202 is selected to operate a document saved in the storage 108 of the image forming apparatus 100. Upon accepting an instruction to the “use saved document” button 202, the CPU 101 causes the display device 110 to display a screen 210. The “transmit” button 203 is selected to use the transmission function of the image forming apparatus 100. Upon accepting an instruction to the “transmit” button 203, the CPU 101 causes the display device 110 to display a screen 220.

The screen 210 is used to operate a document saved in the storage 108. A document list 211 displays a list of documents saved in the storage 108. Each line of the document list 211 indicates one document, and the name and time stamp of the document are displayed there. Upon accepting an instruction to a line of the document list 211, the CPU 101 sets the document corresponding to the line in a selected state. The CPU 101 causes the display device 110 to display a check mark icon 212 at the left end of the line. Note that upon accepting an instruction to the line corresponding to the selected document again, the CPU 101 sets the document corresponding to the like in an unselected state, and causes the display device 110 to stop displaying the check mark icon 212. The user can simultaneously select a plurality of documents. The CPU 101 causes the display device 110 to highlight the finally instructed line and set focus on the document corresponding to the line. In the screen 210 shown in FIG. 2, the focus is set on the document of the third line.

A “combine documents” button 213 is used to combine the selected document. Upon accepting an instruction to the “combine documents” button 213, the CPU 101 combines the currently selected document to generate a new document, and saves it in the storage 108. A “preview” button 214 is used to display preview of a document on which focus is set. The user can refer to the preview of the operation target document by instructing the “preview” button 214. This preview aims at allowing the user to detect a desired document from the documents displayed in the document list 211. Upon accepting an instruction to the “preview” button 214, the CPU 101 generates a preview image from the document on which focus is set. The CPU 101 then causes the display device 110 to display the screen 230.

A “transmit” button 215 is used to transmit the selected document. Upon accepting an instruction to the “transmit” button 215, the CPU 101 causes the display device 110 to display the screen 220. The screen 220 is a basic screen concerning the transmission function of the image forming apparatus 100. Transition occurs from this screen to a screen for doing various kinds of settings concerning transmission of a document.

An “address book” button 221 is used to select and set a transmission destination from a list of destinations registered in the image forming apparatus 100. Upon accepting an instruction to the “address book” button 221, the CPU 101 causes the display device 110 to display a screen (not shown) to display a list of destinations registered in the image forming apparatus 100. The user can set a transmission destination from the screen.

A “preview” button 222 is used to display preview before transmission of a document. This preview aims at allowing the user to finally confirm that the document to be transmitted is correct to prevent a transmission error. In the image forming apparatus 100 according to this embodiment, the flick operation on the display device 110 that employs a touch panel is implemented during the preview. Upon accepting an instruction to the “preview” button 222, the CPU 101 sets the preview before transmission on. The CPU 101 also causes the display device 110 to highlight the “preview” button 222.

Upon accepting an instruction to a start key (not shown) provided on the input device 109 in a state in which the transmission destination is set, the CPU 101 starts document transmission processing. When transition to the screen 220 has occurred in accordance with an instruction to the “transmit” button 203, the CPU 101 controls the scanner device 106 or the document feeder device 107 to read a document and generate the document to be transmitted. On the other hand, when transition to the screen 220 has occurred in accordance with an instruction to the “transmit” button 215, the document selected from the document list 211 in the screen 210 is set as the document to be transmitted. The CPU 101 transmits the transmission target document to an external device via the external interface 111. At this time, if the preview has been set on, the CPU 101 causes the display device 110 to display the screen 230 without immediately starting document transmission. Note that a “format” button 223 will be described in the second embodiment.

The screen 230 is used to preview a document. A preview area 231 is used to display a preview image generate from a preview target document. In this embodiment, as shown in FIG. 2, the CPU 101 causes the display device 110 to display preview images of three pages. A page with a small page number is displayed on the left side of the screen 230, and a page with a large page number is displayed on the right side.

An “OK” button 232 is used to end the preview. When transition to the screen 230 has occurred in accordance with an instruction to the “preview” button 214, the CPU 101 detects an instruction to the “OK” button 232 and causes the display device 110 to display the screen 210, thereby returning to the screen 210. On the other hand, when transition to the screen 230 has occurred in accordance with an instruction to the start key (the preview has been set on by an instruction to the “preview” button 222), the CPU 101 accepts an instruction to the “OK” button 232 and starts transmitting the document.

A “cancel” button 233 is used to cancel document transmission. If the user has found by confirming the preview that the document is not preferable for transmission, he/she can cancel transmission by instructing the button. Only when transition to the screen 230 has occurred in accordance with an instruction to the start key (the preview has been set on by an instruction to the “preview” button 222), the CPU 101 displays the “cancel” button 233. Upon accepting an instruction to the “cancel” button 233, the CPU 101 causes the display device 110 to display the screen 220 without transmitting the document.

Upon detecting a flick operation on the preview area 231, the CPU 101 scrolls the page based on the direction of the flick operation. If the flick operation has been performed to the right, the page (display contents) is scrolled in the direction in which the page number becomes small. If the flick operation has been performed to the left, the page is scrolled in the direction in which the page number becomes large. At the time of page scroll, the CPU 101 moves and displays the preview image with animation in the direction of the flick operation. The CPU 101 controls the speed in the following way. When transition to the screen 230 has occurred in accordance with an instruction to the “preview” button 214, the CPU 101 controls the scroll by the flick operation to a high speed so that the user can quickly grasp the contents of the document. On the other hand, when transition to the screen 230 has occurred in accordance with an instruction to the start key (the preview has been set on by an instruction to the “preview” button 222), the CPU 101 controls the scroll by the flick operation to a low speed so that the user can confirm the adequacy of the document to be transmitted. This is because document transmission starts immediately when the user presses the “OK” button 232 in the screen 230.

<Scroll Display Processing by Flick Operation>

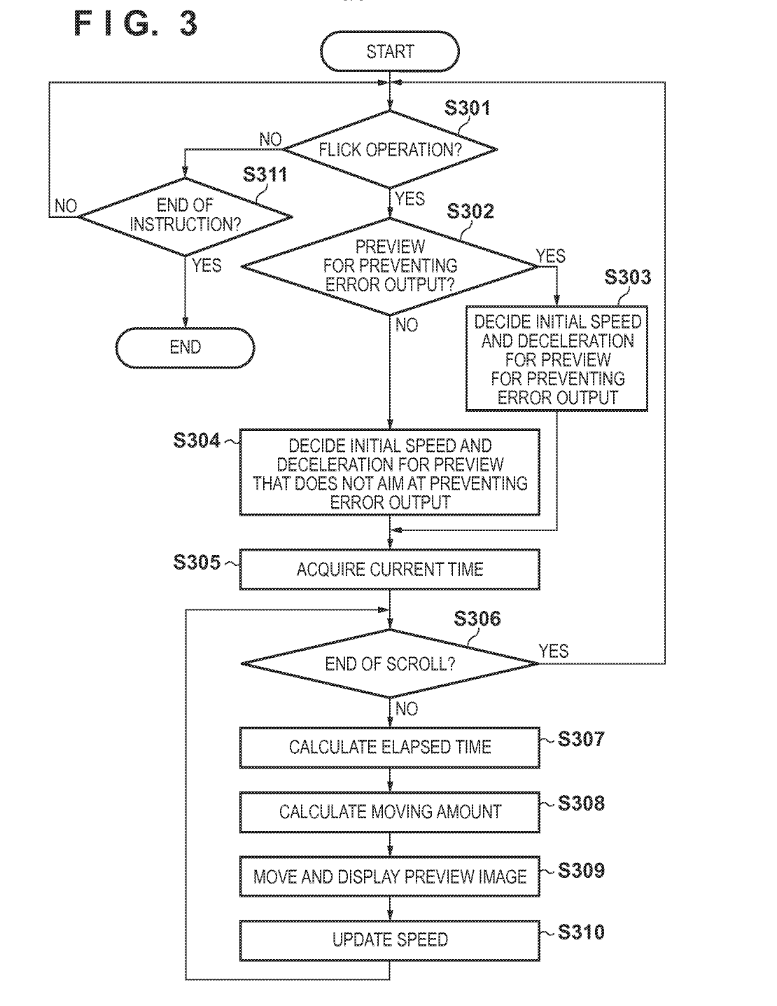

Preview scroll display processing according to this embodiment will be described next with reference to FIG. 3. Processing to be described below is implemented by causing the CPU 101 to read out the controller program stored in the storage 108 to the RAM 104 and execute the program. The CPU 101 starts this processing upon accepting an instruction to the “preview” button 214 via the input device 109. Alternatively, the CPU 101 starts this processing upon accepting an instruction to the start key via the input device 109 when the preview has been set on by an instruction to the “preview” button 222.

The following variables and values are defined. A variable v represents the speed of movement of a preview image during scroll by a flick operation. A variable a represents the deceleration of movement of a preview image during scroll by a flick operation. V1 and V2 represent the speed values of movement of a preview image. A1 and A2 represent the deceleration values of movement of a preview image. These values satisfy the relationships V1>V2 and 0>A1>A2. In addition, a variable tc representing a time and a variable t representing an elapsed time are defined. A variable d representing the moving amount of a preview image is also defined.

In step S301, the CPU 101 determines the presence/absence of a flick operation. When the series of operations (1) to (3) to be described below are detected via the input device 109, the CPU 101 determines that a flick operation has been performed.

(1) First, the CPU 101 detects a touch operation on the preview area 231. (2) Next, the CPU 101 detects movement of a finger that is kept touched. (3) Finally, the CPU 101 detects that the finger has been released from the preview area 231. Note that the control may be done to calculate the time required for (1) to (3) or the distance from the position of (1) to the position of (3), and if the time or distance is smaller than a predetermined threshold, cause the CPU 101 not to determine that a flick operation has been performed. The threshold can be predetermined in consideration of the physical size of the display device 110, the detection sensitivity of the input device 109, and the like. If the CPU 101 has determined that a flick operation has been performed, the process advances to step S302. Otherwise, the process advances to step S311.

In step S302, the CPU 101 functions as a display determination means and determines whether the current display is preview for preventing an error output. More specifically, when transition to the screen 230 has occurred in accordance with an instruction to the start key (the preview has been set on by an instruction to the “preview” button 222), the CPU 101 determines that the preview aims at preventing an error output. On the other hand, when transition to the screen 230 has occurred in accordance with an instruction to the “preview” button 214, the CPU 101 determines that the preview does not aim at preventing an error output. As described above, to determine whether the current display is preview for preventing an error output, the image forming apparatus 100 according to this embodiment uses screen transition history information (operation information) until the current screen is displayed. More specifically, which button in which screen has been pressed to display the current screen is held as history information, and the determination is done using the history information. If the CPU 101 has determined that the current display is preview for preventing an error output, the process advances to step S303. Otherwise, the process advances to step S304.

In step S303, the CPU 101 sets the initial speed and deceleration of page scroll by the flick operation as preview for preventing an error output, and the process advances to step S305. That is, v=V2 and a=A2 are set. The variables v and a are stored in the RAM 104. That is, a lower initial speed and a higher deceleration are selected based on the relationships V1>V2 and 0>A1>A2. As described above, according to this embodiment, if the preview aims at preventing an error output, a relatively low scroll speed (second speed) is selected, thereby controlling to allow the user to properly confirm all pages.

On the other hand, upon determining that the current display is not preview for preventing an error output, the CPU 101 sets the initial speed and deceleration of page scroll by the flick operation in step S304, and the process advances to step S305. That is, v=V1 and a=A1 are set. The variables v and a are stored in the RAM 104. That is, a higher initial speed and a lower deceleration are selected based on the relationships V1>V2 and 0>A1>A2. As described above, according to this embodiment, if the preview does not aim at preventing an error output, a relatively high scroll speed (first speed) is selected, thereby controlling to improve the operability.

In step S305, the CPU 101 acquires and stores the current time. More specifically, the CPU 101 stores the current time in the variable tc and stores it in the RAM 104. In step S306, the CPU 101 determines based on the value of the variable v whether to end the page scroll by the flick operation (end the animation). If the value of the variable v is smaller than a predetermined threshold, the CPU 101 determines to end the movement of the preview image, and the process returns to step S301. Otherwise, the process advances to step S307. Note that the threshold is a value predetermined in consideration of the physical size of the display device 110 and the like.

In step S307, the CPU 101 calculates the elapsed time from the preceding display (preceding display frame in the animation). That is, t=current time−tc is calculated, and the calculated variable t is stored in the RAM 104. At this time, the variable tc is updated to the current time and stored in the RAM 104. In step S308, the CPU 101 calculates the scroll moving amount by the flick operation. This is done by calculating d=v*t+0.5*a*t*t. The moving amount d is the moving amount of the current frame in the animation.

In step S309, the CPU 101 moves each preview image by the moving amount d calculated in step S308 in the direction of the flick operation and displays it on the display device 110. In step S310, the CPU 101 updates the value of the speed v in accordance with the deceleration a. This is done by calculating v=v+a*t. According to this calculation, the speed v is calculated to be considerably lower when a=A2 (when the preview aims at preventing an error output) than when a=A1 (when the preview does not aim at preventing an error output). The calculation result v is stored in the RAM 104. The process then advances to step S306. Note that the processes in steps S306 to S310 correspond to processing of one frame of animation of page scroll by the flick operation.

Upon determining in step S301 that no flick operation has been performed, the process advances to step S311. The CPU 101 determines the presence/absence of a preview end instruction. Upon accepting an instruction to the “OK” button 232 or the “cancel” button 233 via the input device 109, the CPU 101 determines that a preview end instruction has been input, and ends the processing. For otherwise operation, the process returns to step S301.

As described above, in this embodiment, it is determined, in consideration of the functions of the multifunction peripheral and the operation procedure (operation history) for operating it, whether the preview aims at preventing an error output, and the scroll moving speed of the display contents by the flick operation is controlled. More specifically, in preview for detecting a desired document from the document list, the scroll moving speed of the display contents by the flick operation is set to a high speed suitable for grasping the outline of each page of a document. On the other hand, preview immediately before document transmission aims at confirming that the document to be transmitted is an intended correct document, thereby preventing an error output. Hence, the scroll moving speed of the display contents by the flick operation is set to a speed lower than in the above-described preview. This allows the possibility that the user overlooks upon confirming the contents of a document to be reduced, and in turn, reduce the possibility of occurrence of an error output.

Note that in this embodiment, document transmission has been exemplified as image output of a previewed document. However, the same configuration is applicable to printing (image formation on a recording material) such as copy or print. That is, in preview for confirming that a print target document is a desired document immediately before printing, the scroll moving speed of the display contents is reduced. This allows to reduce the risk of resource waste and information leakage by an error output.

### Second Embodiment

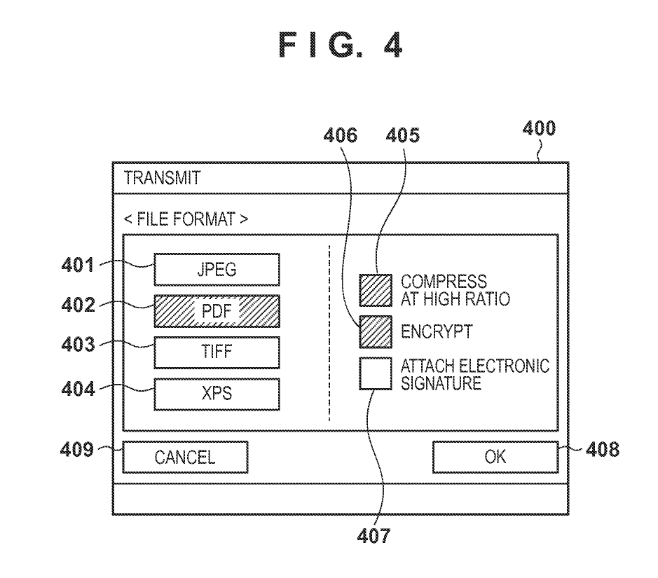

The second embodiment of the present invention will be described below with reference to FIGS. 3 and 4. In this embodiment, the method of determining whether the current preview aims at preventing an error output is different from the first embodiment.

<Display Example>

A display example of a display device 110 according to this embodiment will be described below with reference to FIG. 4. The display example of the display device 110 according to this embodiment is almost the same as the contents described with reference to FIG. 2 in the first embodiment. Only the points of difference from the first embodiment will be explained here. Referring to FIG. 2, a “format” button 223 is used to set the file format of a document to be transmitted. Upon accepting an instruction to the “format” button 223, a CPU 101 causes the display device 110 to display a screen 400 shown in FIG. 4. The screen 400 is used to set the file format of a document to be transmitted. A “JPEG” button 401, a “PDF” button 402, a “TIFF” button 403, and an “XPS” button 404 are used to set the file format of a document to be transmitted. Upon accepting an instruction to one of the buttons 401 to 404, the CPU 101 sets the file format in accordance with the instructed button. When transmitting a document, the CPU 101 converts an image read by a scanner device 106 into a file format corresponding to the setting, and transmits it to an external device via an external interface 111.

A “compress at high ratio” button 405, an “encrypt” button 406, and an “attach digital signature” button 407 are used to do an advanced setting of the file format. These buttons can be instructed when the “PDF” button 402 is instructed to set the file format to PDF. Upon accepting an instruction to the “compress at high ratio” button 405, the CPU 101 sets to compress the document to be transmitted. Upon accepting an instruction to the “encrypt” button 406, the CPU 101 sets to encrypt the document to be transmitted. Upon accepting an instruction to the “attach digital signature” button 407, the CPU 101 sets to attach a digital signature to the document to be transmitted. Upon accepting an instruction to an “OK” button 408, the CPU 101 determines the setting of the file format. The CPU 101 then causes the display device 110 to display a screen 220. On the other hand, upon accepting an instruction to a “cancel” button 409, the CPU 101 cancels the setting of the file format. The CPU 101 then causes the display device 110 to display the screen 220.

<Scroll Display Processing by Flick Operation>

The flowchart illustrating preview page scroll display processing according to this embodiment is the same as in FIG. 3. In this embodiment, only the determination processing in step S302 is different from the first embodiment, and this will be described in detail. That is, the rest of the processing is the same as in the first embodiment, and a description thereof will be omitted.

In step S302, the CPU 101 determines whether the current display is preview for preventing an error output. More specifically, when a setting has been done to encrypt the document to be transmitted or attach an electronic signature via the “encrypt” button 406 or the “attach digital signature” button 407 in the screen 400, the CPU 101 determines that the preview aims at preventing an error output. If YES in step S302, the process advances to step S303. Otherwise, the process advances to step S304.

As described above, in this embodiment, it is determined, in accordance with the document output setting (setting operation), whether the preview aims at preventing an error output, and the scroll moving speed of the display contents by the flick operation is controlled. More specifically, when transmitting a document, it is determined whether a setting to encrypt the document or a setting to attach an electronic signature (both settings concern security) has been done. If the setting concerning security has been done, the scroll moving speed of the display contents by the flick operation is reduced to reduce the possibility that the user overlooks upon confirming the contents of a document.

As another example of determining that the preview aims at preventing an error output, the following condition may be taken into consideration. For example, when a document attached to e-mail is to be transmitted, and significance of the e-mail is set to be higher than usual, the preview may be determined as preview for preventing an error output. When a document in a storage 108 of an image forming apparatus 100 or an external storage is to be output, and a password or a personal identification number has been set for the reference to the storage area, the preview may be determined as preview for preventing an error output. If the attributes of a document to be output include an attribute indicating secrecy, and the attribute has been set to a value indicating secrecy, the preview may be determined as preview for preventing an error output. If a setting has been done to print a watermark or a copy-forgery-inhibited pattern such as “secret” when printing and outputting a document, the preview may be determined as preview for preventing an error output. When a document to be output is analyzed, and an image region including characters such as “secret” or an image representing secrecy is detected in any page, the preview may be determined as preview for preventing an error output. As described above, when outputting a document that needs to secure safety, the image forming apparatus 100 according to this embodiment determines that the preview aims at preventing an error output, and controls to reduce the scroll moving speed of the display contents.

### Third Embodiment

The third embodiment of the present invention will be described below with reference to FIG. 3. In this embodiment, as a method of determining whether preview aims at preventing an error output, a method different from those of the first and second embodiments will be explained.

<Default Settings>

Settings to designate various kinds of operation contents of an image forming apparatus 100, including printing and transmission, can be done by an input device 109. There are various settings such as the number of copies, the color mode, finishing of a printed matter (for example, the presence/absence of stapling or sorting), and the image resolution as well as the transmission destination, the file format, and the presence/absence of preview described above. When the image forming apparatus 100 is powered on and starts operating, a reset key (not shown) provided on the input device 109 is pressed, or an auto clear function operates, the setting contents return to the initial state. The setting contents in the initial state will be referred to as “default settings” hereinafter.

In a recent image forming apparatus such as a multifunction peripheral, the default settings can arbitrarily be done. That is, setting contents when an arbitrary setting operation has been performed can be registered and saved as the default settings. For example, if preview before image output is set on as a setting of transmission processing, and this setting is registered as a default setting, the preview is set on without a preview setting operation (instruction to a “preview” button 222) when returning the mode to the initial state later.

<Scroll Display Processing by Flick Operation>

The flowchart illustrating preview page scroll display processing according to this embodiment is the same as in FIG. 3. Only the determination processing in step S302 is different from the first embodiment, and this will be described in detail. That is, the rest of the processing is the same as in the first embodiment, and a description thereof will be omitted.

In step S302, a CPU 101 determines whether the current display is preview for preventing an error output. More specifically, the CPU 101 determines whether preview on has been registered in the default settings, and the processing procedure has been started based on the settings. If YES in step S302, the process advances to step S303. Otherwise, the process advances to step S304.

As described above, in this embodiment, it is determined, in accordance with registration state of the default operation contents (default settings) of the multifunction peripheral, whether the preview aims at preventing an error output, and the scroll moving speed of the display contents by the flick operation is controlled. If the multifunction peripheral is operated based on default settings in which preview on is registered, the user is supposed to be strongly conscious of preventing an error output. In this case, control is done to reduce the scroll moving speed of the display contents of preview by the flick operation.

Note that the recent multifunction peripheral can store not only the default settings but also arbitrary setting contents in association with an instruction unit such as a button and easily invoke the setting contents by instructing the button. When a preview on setting is stored using this function, preview may be determined as preview for preventing an error output when invoking the setting like the default settings and performing transmission. In this case, control is done to reduce the scroll moving speed of the display contents of preview by the flick operation. That is, in this embodiment, if a setting to preview an output target document is set as predefined default settings, control is done to reduce the scroll moving speed of the display contents of preview by the flick operation.

### Fourth Embodiment

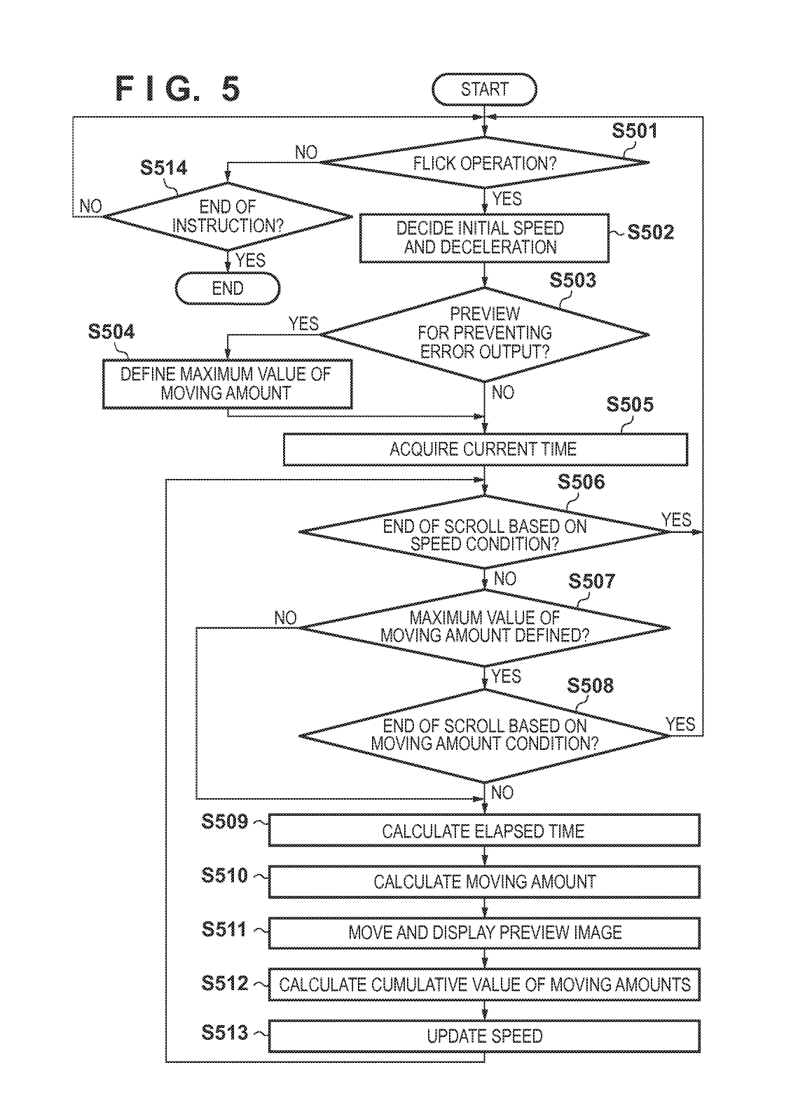

The fourth embodiment of the present invention will be described next with reference to FIG. 5. In the first to third embodiments, control to reduce the scroll moving speed of display contents by a flick operation in preview for preventing an error output has been described. In the fourth embodiment, a method of reducing not the moving speed but the page scroll moving amount will be described. Only an arrangement and control different from the first embodiment will be described below.

Preview scroll display processing according to this embodiment will be described below with reference to FIG. 5. Processing to be described below is implemented by causing a CPU 101 to read out a controller program stored in a storage 108 to a RAM 104 and execute the program. The CPU 101 starts this processing upon accepting an instruction to a “preview” button 214 via an input device 109. Alternatively, the CPU 101 starts this processing upon accepting an instruction to a start key via the input device 109 when the preview has been set on by an instruction to a “preview” button 222.

The following variables and values are defined. A variable v represents the speed of movement of a preview image during scroll by a flick operation. A variable a represents the deceleration of movement of a preview image during scroll by a flick operation. V1 and V2 represent the speed values of movement of a preview image. A1 and A2 represent the deceleration values of movement of a preview image. These values satisfy the relationships V1>V2 and 0>A1>A2. In addition, a variable tc representing a time and a variable t representing an elapsed time are defined. A variable d representing the moving amount of a preview image is also defined.

In step S501, the CPU 101 determines the presence/absence of a flick operation. This processing is the same as in step S301. Upon determining that a flick operation has been performed, the process advances to step S502. Otherwise, the process advances to step S514. In step S502, the CPU 101 decides the initial speed and deceleration of page scroll by the flick operation. That is, v=V1 and a=A1 are set. The variables v and a are stored in the RAM 104. These values are decided based on the size of a display device 110 and the like such that excellent operational feeling can be attained in a flick operation.

In step S503, the CPU 101 functions as a display control means and determines whether the preview aims at preventing an error output. This processing is the same as in step S302. Hence, the determination processing of one of the first to third embodiments is applicable. Upon determining that the preview aims at preventing an error output, the process advances to step S504. Otherwise, the process advances to step S505.

In step S504, the CPU 101 defines the maximum value of the moving amount of the preview image by the flick operation. That is, the value is stored in the RAM 104, and the process advances to step S505. The maximum value is, for example, the value of movement of the preview image that moves by one page. On the other hand, upon determining that the preview does not aim at preventing an error output, the process advances to step S505 without setting the maximum value of the moving amount of the preview image. As described above, according to this embodiment, if the preview aims at preventing an error output, a relatively small moving amount (second moving amount) is selected, thereby controlling to allow the user to properly confirm all pages. Note that in the above-described example, when it is determined that the preview does not aim at preventing an error output, the maximum value of the moving amount of the preview image is not set. However, a first moving amount larger than the second moving amount may be set as the maximum value. In step S505, the CPU 101 acquires and stores the current time. More specifically, the CPU 101 stores the current time in the variable tc and stores it in the RAM 104.

In step S506, the CPU 101 determines based on the value of the variable v whether to end the page scroll by the flick operation (end the animation). This processing is the same as in step S306. Upon determining to end the movement of the preview image, the process returns to step S501. Otherwise, the process advances to step S507.

In step S507, the CPU 101 determines whether step S504 has been executed, and the maximum value of the moving amount of the preview image has been stored in the RAM 104. Upon determining that the maximum value of the moving amount of the preview image has been stored, the process advances to step S508. Otherwise, the process advances to step S509. In step S508, the CPU 101 determines based on the value of a variable ds whether to end the page scroll by the flick operation (end the animation). More specifically, if the value of the variable ds is larger than the maximum value of the moving amount of the preview image stored in the RAM 104 in step S504, the CPU 101 determines to end the scroll of the preview image, and the process returns to step S501. Otherwise, the process advances to step S509.

In step S509, the CPU 101 calculates the elapsed time from the preceding display (preceding display frame in the animation). This processing is the same as in step S307. In step S510, the CPU 101 calculates the moving amount by the preview image. This processing is the same as in step S308. In step S511, the CPU 101 moves each preview image by the moving amount calculated in step S510 in the direction of the flick operation and displays it on the display device 110.

In step S512, the CPU 101 calculates the cumulative value of the moving amounts. This is done by calculating ds=ds+d. The variable ds is stored in the RAM 104. In step S513, the CPU 101 updates the value of the speed v in accordance with the deceleration a. This processing is the same as in step S310. Note that the processes in steps S506 to S513 correspond to processing of one frame of animation of page scroll by the flick operation.

Upon determining in step S501 that no flick operation has been performed, the process advances to step S514. The CPU 101 determines the presence/absence of a preview end instruction. This processing is the same as in step S311. Upon determining that a preview end instruction has been input, the processing ends. Otherwise, the process returns to step S501.

As described above, according to this embodiment, if it is determined that the preview aims at preventing an error output, the moving amount of the page scroll by the flick operation is reduced. This allows to reduce the possibility that the user overlooks upon confirming a document, and in turn, reduce the possibility of occurrence of an error output. Note that this embodiment can use the determination processes described in the first to third embodiments.

### Other Embodiments

It is possible to form one apparatus by combining the above-described embodiments. In this case, the operations described in the respective embodiments may be provided as operation modes, and the mode may automatically be switched based on an arbitrary condition. Alternatively, the user may be able to manually switch the operation mode by inputting an instruction.

In the above description of the embodiments, a digital multifunction peripheral has been exemplified as the image forming apparatus for implementing the present invention. However, the image forming apparatus for implementing the present invention is not limited to the digital multifunction peripheral. That is, the present invention is applicable not only to the digital multifunction peripheral but also to any image forming apparatus having the function of displaying a preview image such as a printing apparatus, a scanner, a FAX apparatus, a digital camera, a PC, or a portable information terminal.

In the above description of the embodiments, a flick operation has been exemplified as the operation performed by the user to do scroll display. However, the present invention can also be implemented even when the operation performed by the user to do scroll display is not limited to the flick operation. For example, the present invention can be implemented if the scroll display can be done by an operation other than flick on the touch panel. That is, the present invention can be implemented if a displayed image is scrolled by a predetermined operation by the user. The predetermined operation can be another gesture operation performed by touching the touch panel or a gesture operation (so-called space gesture operation) performed without touching the touch panel in addition to the flick operation on the touch panel. As for display of an image to be scrolled, the image need not always be displayed on a display unit including a touch panel. The image may be projected to some kind of screen using an image projection apparatus such as a projector. The projected image may be scrolled by performing a predetermined operation (space gesture operation) for the image.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording material of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-027726 filed on Feb. 10, 2012, which is hereby incorporated by reference herein in its entirety.

What is claimed is:

1. An image forming apparatus including a display unit that accepts a touch input operation, comprising:
a display determination unit configured to determine whether or not contents currently displayed on said display unit represent preview for preventing an error output of a document by the image forming apparatus in a case where said display unit accepts a touch input operation for scrolling display contents; and
a setting unit configured to set a scroll speed of the display contents by the touch input operation to a first speed in a case where said display determination unit has determined that said display unit is not displaying the preview for preventing the error output, and sets the scroll speed of the display contents by the touch input operation to a second speed lower than the first speed in a case where said display determination unit has determined that said display unit is displaying the preview for preventing the error output.

2. An image forming apparatus including a display unit that accepts a touch input operation, comprising:
a display determination unit configured to determine whether or not contents currently displayed on said display unit represent preview for preventing an error output of a document by the image forming apparatus in a case where said display unit accepts a touch input operation for scrolling display contents; and
a setting unit configured to set a scroll moving amount of the display contents by the touch input operation to a first moving amount in a case where said display determination unit has determined that said display unit is not displaying the preview for preventing the error output, and sets the scroll moving amount of the display contents by the touch input operation to a second moving amount smaller than the first moving amount in a case where said display determination unit has determined that said display unit is displaying the preview for preventing the error output.

3. The apparatus according to claim 1, wherein said display determination unit determines that the preview is the preview for preventing the error output in a case where operation information until transition to a screen currently displayed by said display unit indicates that the document is to be output as an image immediately after the preview is displayed, and otherwise, determines that the preview is not the preview for preventing the error output.

4. The apparatus according to claim 1, wherein said display determination unit determines that the preview is the preview for preventing the error output in a case where a setting concerning security has been done in output settings of the document, and otherwise, determines that the preview is not the preview for preventing the error output.

5. The apparatus according to claim 1, wherein said display determination unit determines that the preview is the preview for preventing the error output in a case where a setting to preview before image output has been done in default settings of the image output by the image forming apparatus, and otherwise, determines that the preview is not the preview for preventing the error output.

6. The apparatus according to claim 1, further comprising an image output unit configured to transmit the previewed document to an external device connected via a network or forms an image of the document on a recording material.

7. A method of controlling an image forming apparatus including a display unit that accepts a touch input operation, comprising:
determining whether or not contents currently displayed on the display unit represent preview for preventing an error output of a document by the image forming apparatus in a case where the display unit accepts a touch input operation for scrolling display contents; and
setting a scroll speed of the display contents by the touch input operation to a first speed in a case where it is determined in the determining that the display unit is not displaying the preview for preventing the error output, and setting the scroll speed of the display contents by the touch input operation to a second speed lower than the first speed in a case where it is determined in the determining that the display unit is displaying the preview for preventing the error output.

8. A method of controlling an image forming apparatus including a display unit that accepts a touch input operation, comprising:
determining whether or not contents currently displayed on the display unit represent preview for preventing an error output of a document by the image forming apparatus in a case where the display unit accepts a touch input operation for scrolling display contents; and
setting a scroll moving amount of the display contents by the touch input operation to a first moving amount in a case where it is determined in the determining that the display unit is not displaying the preview for preventing the error output, and setting the scroll moving amount of the display contents by the touch input operation to a second moving amount smaller than the first moving amount in a case where it is determined in the determining that the display unit is displaying the preview for preventing the error output.

9. A computer-readable storage medium storing a computer program that causes a computer to execute each step of an image forming apparatus control method of claim 7.

10. A computer-readable storage medium storing a computer program that causes a computer to execute each step of an image forming apparatus control method of claim 8.
